(19) United States
(12) Patent Application Publication
(10) Pub. No.: US 2020/0036934 A1
(43) Pub. Date: Jan. 30, 2020

(54) METHOD FOR ADJUSTING A SCREEN BRIGHTNESS AND A DEVICE THEREOF

(71) Applicant: Wuhan China Star Optoelectronics Technology Co., Ltd, Wuhan, Hubei (CN)

(72) Inventors: Yong YANG, Wuhan, Hubei (CN); Yingbao YANG, Wuhan, Hubei (CN)

(21) Appl. No.: 15/735,485

(22) PCT Filed: Nov. 14, 2017
(86) PCT No.: PCT/CN2017/110925

§ 371 Date: Dec. 11, 2017

(30) Foreign Application Priority Data
Oct. 31, 2017 (CN) 201711047999.5

(51) Int. Cl. H04N 5/58; H04N 13/383; H04N 21/422

(52) U.S. Cl. CPC H04N 5/58; H04N 21/42202; H04N 13/383

(57) ABSTRACT

The disclosure provides a method for adjusting a screen brightness including the following steps: obtaining a position of a maximum brightness region of visible light in a viewable range of a human eye; and adjusting the screen brightness based on a brightness of the position of the maximum brightness region of visible light in the viewable range of the human eye and a variation of a size a pupil of the human eye. A device for adjusting screen brightness is also provided, including a light sensor, a brightness analyzer, a brightness adjustment and control unit. Compared with the conventional technique, the accuracy of adjusting a brightness of a screen and the convenience of eye watching are improved and the eye health protection is achieved.

### RELATED APPLICATIONS

The present application is a National Phase of International Application Number PCT/CN2017/110925, filed Nov. 14, 2017, and claims the priority of China Application No. 201711047999.5, filed Oct. 31, 2017.

### FIELD OF THE DISCLOSURE

The disclosure relates to a display panel, and more particularly to a method for adjusting a screen brightness and a device thereof.

### BACKGROUND

The more popular the small size display panel such as cellphone and tablet PC, the longer the time people using the electronic products. However, using the display products overtime not only leads to the fatigue of the human eyes, but as well as does the irreversible damage on the retina of the human eyes in long term and the vision of the individual is influenced. Hence, now certain cellphone manufacturers have developed a system of intelligent backlight adjustment to prevent the damage of the display panel of the cellphone. However, the standards of such adjustment techniques in market vary, and there is no sufficient scientific basis for the adjustment of the backlight and the brightness of the screen of the cellphone. In such way, the eye health protection cannot be achieved and more damage to the human eye may be resulted in.

### SUMMARY

For the above problem, the disclosure provides a method for adjusting the brightness of the screen and a device thereof so as to improve the accuracy of adjusting a screen brightness and the convenience of eye watching.

The disclosure provides a method for adjusting a screen brightness including the following steps: obtaining a position of a maximum brightness region of visible light in a viewable range of a human eye; and adjusting the screen brightness based on a brightness of the position of the maximum brightness region of visible light in the viewable range of the human eye and a variation of a pupil size of the human eye.

In advance, obtaining the position of the maximum brightness region of visible light in the viewable range of the human eye comprises: determining the position of the maximum brightness region of visible light in the viewable range of the human eye; when the position of the maximum brightness region of visible light in the viewable range of the human eye is outside of the screen, obtaining a brightness of ambient light outside of the screen and the pupil size of the human eye; and adjusting the screen brightness based on the brightness of ambient light outside of the screen and the variation of the pupil size of the human eye.

In advance, when the position of the maximum brightness region of visible light in the viewable range of the human eye is inside of the screen, the screen brightness is adjusted based on a variation of the brightness of ambient light.

In advance, adjusting the screen brightness based on the brightness of ambient light outside of the screen and the variation of the pupil size of the human eye comprises: determining whether the maximum brightness of ambient light is higher than the screen brightness; determining the pupil size of the human eye; increasing the screen brightness when the maximum brightness of ambient light is higher than the screen brightness and the pupil size of the human eye decreases; and decreasing the screen brightness when the maximum brightness of ambient light is lower than the screen brightness and the pupil size of the human eye increases.

The disclosure further provides a device for adjusting the screen brightness. The device includes: a light sensor, configured to obtain a maximum brightness of visible light in a viewable range of a human eye; a brightness analyzer, configured to analyze a position of a maximum brightness region of visible light, and to generate a corresponding control signal based on the position of the maximum brightness region of visible light and a variation of a pupil size of the human eye; and a brightness adjustment and control device, configured to receive the corresponding control signal and to adjust the screen brightness based on the corresponding control signal.

In advance, the device further includes an eyeball tracking device configured to obtain the variation of the pupil size of the human eye.

In advance, the brightness analyzer is further configured to determine the position of the maximum brightness region of visible light in a viewable range of the human eye, and to obtain a maximum brightness of ambient light outside of the screen and the pupil size of the human eye when the position of the maximum brightness region of visible light in the viewable range of the human eye is outside of the screen, and to generate the corresponding control signal based on the maximum brightness of ambient light outside of the screen and the variation of the pupil size of the human eye.

In advance, the brightness analyzer generates the corresponding control signal based on a variation of the brightness of ambient light when the position of the maximum brightness region of visible light in the viewable range of the human eye is inside of the screen.

In advance, to generate the corresponding control signal based on the maximum brightness of ambient light outside of the screen and the variation of the pupil size of the human eye comprises: determining whether a maximum brightness of ambient light is higher than the screen brightness of the screen; determining the pupil size of the human eye; increasing the screen brightness when the maximum brightness of ambient light is higher than the screen brightness and the size of the pupil of the human eye decreases; and decreasing the screen brightness when the maximum brightness of ambient light is lower than the screen brightness and the pupil size of the human eye increases.

Compared with the conventional technique, the disclosure, by obtaining the position of the maximum brightness region of visible light in the viewable range of the human eye and by adjusting the screen brightness based on the brightness of the position of the maximum brightness region of visible light and/or the variation of the pupil size of the human eye, improves the accuracy of adjusting a screen brightness and the convenience of eye watching, and achieve the eye health protection.

### BRIEF DESCRIPTION OF THE DRAWINGS

Accompanying drawings are for providing further understanding of embodiments of the disclosure. The drawings form a part of the disclosure and are for illustrating the principle of the embodiments of the disclosure along with the literal description. Apparently, the drawings in the description below are merely some embodiments of the disclosure, a person skilled in the art can obtain other drawings according to these drawings without creative efforts. In the figures:

FIG. 1 is a flowchart of the disclosure;

FIG. 2 is a schematic diagram of the device for adjusting the brightness of the screen of the disclosure;

FIG. 3 is a flowchart of the disclosure; and

FIG. 4 is a schematic of the viewable range of the human eye.

### DETAILED DESCRIPTION OF PREFERRED EMBODIMENTS

The specific structural and functional details disclosed herein are only representative and are intended for describing exemplary embodiments of the disclosure. However, the disclosure can be embodied in many forms of substitution, and should not be interpreted as merely limited to the embodiments described herein.

In the description of the disclosure, terms such as “center”. “transverse”, “above”, “below”, “left”, “right”, “vertical”, “horizontal”, “top”, “bottom”, “inside”. “outside”, etc. for indicating orientations or positional relationships refer to orientations or positional relationships as shown in the drawings; the terms are for the purpose of illustrating the disclosure and simplifying the description rather than indicating or implying the device or element must have a certain orientation and be structured or operated by the certain orientation, and therefore cannot be regarded as limitation with respect to the disclosure. Moreover, terms such as “first” and “second” are merely for the purpose of illustration and cannot be understood as indicating or implying the relative importance or implicitly indicating the number of the technical feature. Therefore, features defined by “first” and “second” can explicitly or implicitly include one or more the features. In the description of the disclosure, unless otherwise indicated, the meaning of “plural” is two or more than two. In addition, the term “comprise” and any variations thereof are meant to cover a non-exclusive inclusion.

In the description of the disclosure, is should be noted that, unless otherwise clearly stated and limited, terms “mounted”, “connected with” and “connected to” should be understood broadly, for instance, can be a fixed connection, a detachable connection or an integral connection; can be a mechanical connection, can also be an electrical connection; can be a direct connection, can also be an indirect connection by an intermediary, can be an internal communication of two elements. A person skilled in the art can understand concrete meanings of the terms in the disclosure as per specific circumstances.

The terms used herein are only for illustrating concrete embodiments rather than limiting the exemplary embodiments. Unless otherwise indicated in the content, singular forms “a” and “an” also include plural. Moreover, the terms “comprise” and/or “include” define the existence of described features, integers, steps, operations, units and/or components, but do not exclude the existence or addition of one or more other features, integers, steps, operations, units, components and/or combinations thereof.

The disclosure will be further described in detail with reference to accompanying drawings and preferred embodiments as follows.

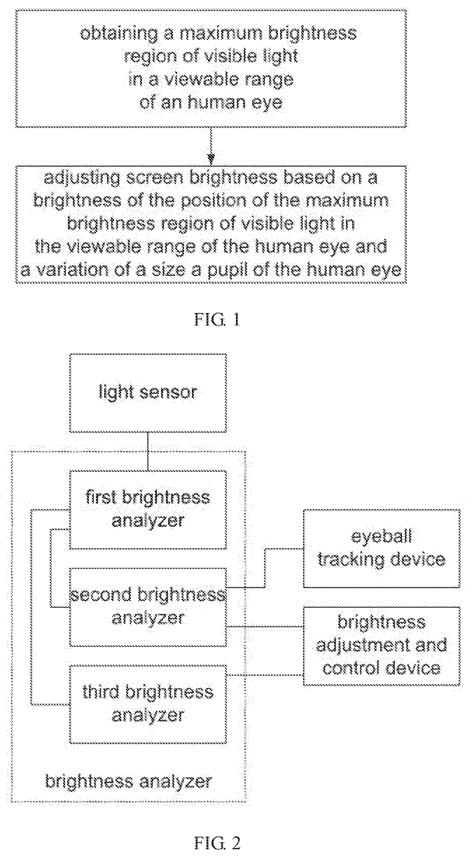

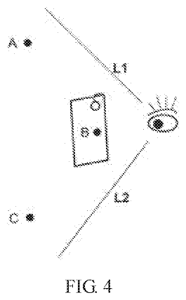

As shown in FIG. 1 and FIG. 4, the disclosure provides a method for adjusting the screen brightness including the following steps: obtaining a position of the maximum brightness region of visible light in a viewable range of a human eye; and adjusting the screen brightness based on a brightness of the position of the maximum brightness region of visible light in the viewable range of the human eye and a variation of a pupil size of the human eye.

In one embodiment, the step of obtaining the position of the maximum brightness region of visible light in the viewable range of the human eye is to determine the position of the maximum brightness region of visible light in the viewable range of the human eye. Normally, the maximum brightness region of visible light is either inside of the screen and corresponding to the screen brightness, such as the spot B in FIG. 4, or outside of the screen and corresponding to the brightness of ambient light, such as the spot A and the spot C in FIG. 4. According to such principle, when the position of the maximum brightness region of visible light in the viewable range of the human eye is outside of the screen, the brightness of ambient light outside of the screen and the pupil size of the human eye are obtained so as to adjust the screen brightness based on the brightness of ambient light outside of the screen and the variation of the pupil size of the human eye. In FIG. 4, the region between the line L1 and the line L2 is the viewable range of the human eye.

In one embodiment, the step of adjusting the screen brightness is to increase the screen brightness or to decrease the screen brightness.

In one embodiment, the step of adjusting the screen brightness based on the brightness of ambient light outside of the screen and the variation of the pupil size of the human eye includes the following steps: determining whether a maximum brightness of ambient light is higher than the screen brightness; determining the pupil size of the human eye; increasing the screen brightness when the maximum brightness of ambient light is higher than the screen brightness and the pupil size of the human eye decreases; and decreasing the screen brightness when the maximum brightness of ambient light is lower than the screen brightness and the pupil size of the human eye increases.

The following equation is able to be used for calculating the corresponding screen brightness in the step of adjusting the screen brightness based on the brightness of ambient light outside of the screen and the variation of the pupil size of the human eye:

L=kL₀×exp(d/d₀),

Herein, k is a coefficient of ratio, L₀ is the screen brightness with standard brightness of ambient light, d₀ is the pupil size of the human eye with standard brightness of ambient light, and d is the pupil size of the human eye with certain brightness of ambient light.

With the above equation, the display curve meeting the characteristic of brightness of the human eye can be calculated, but the disclosure does not limit the scope thereto. In another embodiment, a lookup table may be generated to build a relationship between the pupil size of the human eye and the brightness of ambient light so as to adjust the screen brightness accordingly.

When the position of the maximum brightness region of visible light in the viewable range of the human eye is inside of the screen, the screen brightness is adjusted based on the variation of the brightness of ambient light.

When the position of the maximum brightness region of visible light is inside of the screen, it is assumed that the spot B has the maximum brightness in the first environment. When the person moves to the second environment or the environment changes and the spot B still has the maximum brightness, it is assumed that the brightness of ambient light in the first environment is M and the brightness of the spot B in the first environment is L and the brightness of ambient light in the second environment is N, and the brightness of the spot B in the second environment can be calculated as NL/M. Because the brightness of ambient light in the second environment may be higher than or less than the brightness of ambient light in the first environment, the brightness of the spot B may increase or decrease. Hence, to adjust a screen brightness only needs to increase or decrease the screen brightness based on a ratio between the screen brightness and the brightness of ambient light directly proportionally. The adjustment method is, for example, the conventional adjustment method which means to adjust the screen brightness as bright as the brightness of ambient light.

As shown in FIG. 2, the disclosure further provides a device for adjusting the screen brightness includes the following elements.

A light sensor is configured to obtain a maximum brightness of visible light in a viewable range of a human eye.

A brightness analyzer is configured to analyze a position of a maximum brightness region of visible light, and to generate a corresponding control signal based on the position of the maximum brightness region of visible light and a variation of pupil size of the human eye.

A brightness adjustment and control device is configured to receive the corresponding control signal and to adjust the screen brightness based on the corresponding control signal.

The brightness adjustment and control device further has an eyeball tracking device configured to obtain the variation of the pupil size of the human eye.

The control signal is a signal controlling the voltage of the backlight control circuit. Adjusting the screen brightness is, for example, increasing the screen brightness or decreasing the screen brightness.

The brightness analyzer is further configured to determine the position of the maximum brightness region of visible light in a viewable range of the human eye, and to obtain a maximum brightness of ambient light outside of the screen and the pupil size of the human eye when the position of the maximum brightness region of visible light in the viewable range of the human eye is outside of the screen, and to generate the corresponding control signal based on the maximum brightness of ambient light outside of the screen and the variation of the pupil size of the human eye.

In advance, the brightness analyzer generates the corresponding control signal based on a variation of the brightness of ambient light when the position of the maximum brightness region of visible light in the viewable range of the human eye is inside of the screen.

When the position of the maximum brightness region of visible light is inside of the screen, it is assumed that the spot B has the maximum brightness in the first environment. When the person moves to the second environment or the environment changes and the spot B still has the maximum brightness, it is assumed that the brightness of ambient light in the first environment is M and the brightness of the spot B in the first environment is L and the brightness of ambient light in the second environment is N, and the brightness of the spot B in the second environment can be calculated as NL/M. Because the brightness of ambient light in the second environment may be higher than or less than the brightness of ambient light in the first environment, the brightness of the spot B may increase or decrease. Hence, to adjust a screen brightness only needs to increase or decrease the screen brightness based on a ratio between the screen brightness and the brightness of ambient light directly proportionally. The adjustment method is, for example, the conventional adjustment method which means to adjust the screen brightness as bright as the brightness of ambient light.

In one embodiment, the step of adjusting the screen brightness based on the brightness of ambient light outside of the screen and the variation of the pupil size of the human eye includes the following steps: determining whether a maximum brightness of ambient light is higher than the screen brightness; determining the pupil size of the human eye; increasing the screen brightness when the maximum of the brightness of ambient light is higher than the screen brightness and the pupil size of the human eye decreases; and decreasing the screen brightness when the maximum brightness of ambient light is lower than the screen brightness and the pupil size of the human eye increases.

The following equation is able to be used for calculating the corresponding screen brightness in the step of adjusting the screen brightness based on the brightness of ambient light outside of the screen and the variation of the pupil size of the human eye:

L=kL₀×exp(d,d₀),

Herein, k is a coefficient of ratio, L₀ is the screen brightness with standard brightness of ambient light, d₀ is the pupil size of the human eye with standard brightness of ambient light, and d is the pupil size of the human eye with certain brightness of ambient light.

With the above equation, the display curve meeting the characteristic of brightness of the human eye can be calculated, but the disclosure does not limit the scope thereto. In another embodiment, a lookup table may be generated to build a relationship between the pupil size of the human eye and the brightness of ambient light so as to adjust the screen brightness accordingly.

In one embodiment of the disclosure, the brightness analyzer includes a first brightness analyzer, a second brightness analyzer, and a third brightness analyzer.

The first brightness analyzer is configured to analyze the position of the maximum brightness region of ambient light.

The second brightness analyzer is configured to generate the corresponding control signal based on the maximum brightness of ambient light outside of the screen and the pupil size of the human eye when the position of the maximum brightness region of visible light in the viewable range of the human eye is outside of the screen. In one embodiment, when the position of the maximum brightness region of visible light in the viewable range of the human eye is outside of the screen, the first brightness analyzer sends an obtaining instruction to the second brightness analyzer.

The third brightness analyzer is configured to generate the corresponding control signal based on the variation of the brightness of ambient light when the position of the maximum brightness region of visible light in the viewable range of the human eye is inside of the screen. In one embodiment, when the position of the maximum brightness region of visible light in the viewable range of the human eye is inside of the screen, the first brightness analyzer sends an obtaining instruction to the third brightness analyzer.

In one embodiment of the disclosure, the light sensor and the eyeball tracking device is installed in the position corresponding to the human eyes.

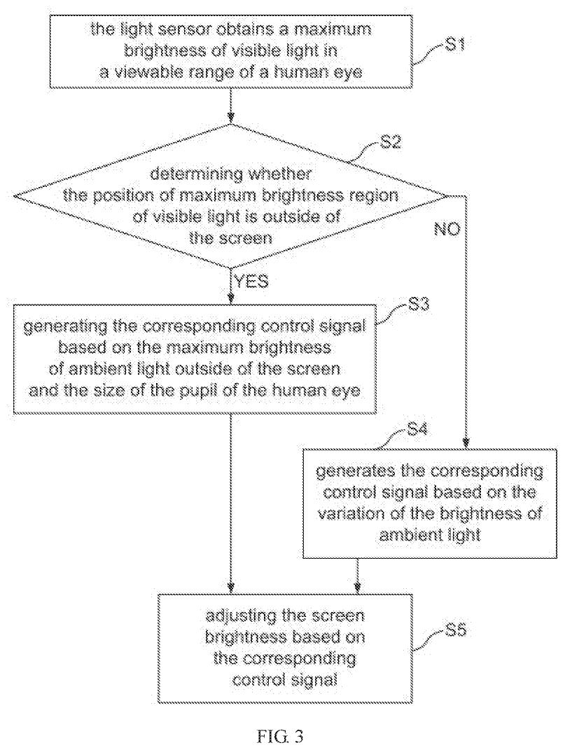

In the following, the method for adjusting a screen brightness and the device thereof in the disclosure are combined to illustrate the explicit flow of the disclosure, as shown in FIG. 3:

Step S1, the light sensor obtains a maximum brightness of visible light in a viewable range of a human eye;

Step S2, the first brightness analyzer determines whether the position of maximum brightness region of visible light is outside of the screen based on the maximum brightness of visible light in the viewable range of the human eye;

Step S3, when the position of maximum brightness region of visible light in the viewable range of the human eye is outside of the screen (YES), the second brightness analyzer generates the corresponding control signal based on the maximum brightness of ambient light outside of the screen and the pupil size of the human eye and sends the corresponding control signal to the brightness adjustment and control device:

Step S4, when the position of maximum brightness region of visible light in the viewable range of the human eye is inside of the screen (NO), the third brightness analyzer generates the corresponding control signal based on the variation of the brightness of ambient light and sends the corresponding control signal to the brightness adjustment and control device.

Step S5, the brightness adjustment and control device adjusts the screen brightness based on the corresponding control signal.

In one embodiment of the disclosure, the brightness adjustment and control device adjusts the backlight of the screen. That is, the adjustment is done by adjusting the voltage of the backlight control circuit.

In the disclosure, by adding the human eye brightness light sensor in the display device such as cellphone or displayer, and by sensing the brightness of ambient light and the pupil size of the human eye together to adjust the brightness of the display device, the convenience of eye watching is improved and the eye health protection is achieved.

The foregoing contents are detailed description of the disclosure in conjunction with specific preferred embodiments and concrete embodiments of the disclosure are not limited to these description. For the person skilled in the art of the disclosure, without departing from the concept of the disclosure, simple deductions or substitutions can be made and should be included in the protection scope of the application.

What is claimed is:

1. A method for adjusting a screen brightness, comprising:
obtaining a position of a maximum brightness region of visible light in a viewable range of a human eye; and
adjusting screen brightness based on a brightness of the position of the maximum brightness region of visible light in the viewable range of the human eye and a variation of pupil size of the human eye.

2. The method for adjusting the screen brightness according to claim 1, wherein obtaining the position of the maximum brightness region of visible light in the viewable range of the human eye comprises:
determining the position of the maximum brightness region of visible light in the viewable range of the human eye;
when the position of the maximum brightness region of visible light in the viewable range of the human eye is outside of the screen, obtaining a brightness of ambient light outside of the screen and the size of the pupil of the human eye; and
adjusting the screen brightness based on the brightness of ambient light outside of the screen and the variation of the pupil size of the human eye.

3. The method for adjusting the screen brightness according to claim 2, further comprises: adjusting the screen brightness based on a variation of the brightness of ambient light when the position of the maximum brightness region of visible light in the viewable range of the human eye is inside of the screen.

4. The method for adjusting the brightness of the screen according to claim 2, wherein adjusting the screen brightness based on the brightness of ambient light outside of the screen and the variation of the pupil size of the human eye comprises:
determining whether a maximum brightness of ambient light is higher than the screen brightness and determining the pupil size of the human eye;
increasing the screen brightness when the maximum brightness of ambient light is higher than the screen brightness as the pupil size of the human eye decreases; and
decreasing the screen brightness when the maximum brightness of ambient light is lower than the screen brightness as the pupil size of the human eye increases.

5. A method for adjusting a screen brightness, comprising:
obtaining a position of a maximum brightness region of visible light in a viewable range of a human eye; and
adjusting the screen brightness based on a brightness of the position of the maximum brightness region of visible light in the viewable range of the human eye or a variation of the pupil size of the human eye.

6. A device for adjusting a screen brightness, wherein the device comprises:
a light sensor, configured to obtain a maximum brightness of visible light in a viewable range of a human eye;
a brightness analyzer, configured to analyze a position of a maximum brightness region of visible light, and to generate a corresponding control signal based on the position of the maximum brightness region of visible light and a variation of pupil size of the human eye; and
a brightness adjustment and control device, configured to receive the corresponding control signal and to adjust the screen brightness based on the corresponding control signal.

7. The device for adjusting the screen brightness according to claim 6, wherein the brightness adjustment and control device further comprises an eyeball tracking device configured to obtain the variation of the pupil size of the human eye.

8. The device for adjusting the screen brightness according to claim 6, wherein the brightness analyzer is further configured to determine the position of the maximum brightness region of visible light in a viewable range of the human eye, and to obtain a maximum brightness of ambient light outside of the screen and the size of the pupil of the human eye when the position of the maximum brightness region of visible light in the viewable range of the human eye is outside of the screen, and to generate the corresponding control signal based on the maximum brightness of ambient light outside of the screen and the variation of the size of the pupil of the human eye.

9. The device for adjusting the screen brightness according to claim 7, wherein the brightness analyzer is further configured to determine the position of the maximum brightness region of visible light in a viewable range of the human eye, and to obtain a maximum brightness of ambient light outside of the screen and the size of the pupil of the human eye when the position of the maximum brightness region of visible light in the viewable range of the human eye is outside of the screen, and to generate the corresponding control signal based on the maximum brightness of ambient light outside of the screen and the variation of the pupil size of the human eye.

10. The device for adjusting the screen brightness according to claim 8, wherein the brightness analyzer generates the corresponding control signal based on a variation of the brightness of ambient light when the maximum brightness region of visible light in the viewable range of the human eye is inside of the screen.

11. The device for adjusting the screen brightness according to claim 9, wherein the brightness analyzer generates the corresponding control signal based on a variation of the brightness of ambient light when the position of the maximum brightness region of visible light in the viewable range of the human eye is inside of the screen.

12. The device for adjusting the brightness of the screen according to claim 8, wherein to generate the corresponding control signal based on the maximum brightness of ambient light outside of the screen and the variation of the pupil size of the human eye comprises:
determining whether a maximum brightness of ambient light is higher than the screen brightness; and determining the pupil size of the human eye;
increasing the screen brightness when the maximum brightness of ambient light is higher than the screen brightness and the pupil size of the human eye decreases; and
decreasing the screen brightness when the maximum brightness of ambient light is lower than the screen brightness and the pupil size of the human eye increases.

13. The device for adjusting the screen brightness according to claim 9, wherein to generate the corresponding control signal based on the maximum brightness of ambient light outside of the screen and the variation of the pupil size of the human eye comprises:
determining whether a maximum brightness of ambient light is higher than the screen brightness and determining the pupil size of the human eye;
increasing the screen brightness when the maximum brightness of ambient light is higher than the screen brightness and the pupil size of the human eye decreases; and
decreasing the screen brightness when the maximum brightness of ambient light is lower than the screen brightness and the pupil size of the human eye increases.
